(19) United States
(12) Patent Application Publication
(10) Pub. No.: US 2025/0202115 A1
(43) Pub. Date: Jun. 19, 2025

(54) RADIATOR ASSEMBLY FOR BASE STATION ANTENNAS

(71) Applicant: Outdoor Wireless Networks LLC, Claremont, NC (US)

(72) Inventors: Jian ZHANG, Suzhou, Jiangsu (CN); Bin SUN, Suzhou, Jiangsu (CN); Cheng XUE, Suzhou, Jiangsu (CN); YueMin LI, Suzhou, Jiangsu (CN); Bo WU, Allen, TX (US)

(21) Appl. No.: 18/847,978

(22) PCT Filed: Mar. 30, 2023
(86) PCT No.: PCT/US2023/065135

§ 371 Date: Sep. 17, 2024

(30) Foreign Application Priority Data
Apr. 1, 2022 (CN) 202210347032.3

(51) Int. Cl. H01Q 5/48; H01Q 1/24; H01Q 21/26

(52) U.S. Cl. CPC H01Q 5/48; H01Q 1/246; H01Q 21/26

(57) ABSTRACT

A dual-polarized radiator assembly for base station antennas, which includes two orthogonal dipoles, where each dipole includes two dipole arms and each dipole arm has a radiating portion. Each radiating portion may be a sheet metal component and have an outer contour that forms a first square, in which, two adjacent inner sides of every two adjacent first squares extend parallel to each other. The radiator assembly may have a compact size and may have improved cloaking performance.

### CROSS-REFERENCE TO RELATED APPLICATION

The present application claims the benefit of priority to Chinese Patent Application No. 202210347032.3, filed on Apr. 1, 2022, with the China National Intellectual Property Administration, and the entire contents of the above-identified application are incorporated by reference as if set forth herein.

### TECHNICAL FIELD

The present application relates to base station antennas, and more specifically, to radiator assemblies for base station antennas.

### BACKGROUND

Cellular communication systems may include a base station, which may include one or more base station antennas. The base station antennas may connect user radio devices such as, for example, smart phones, to the radio communication network. A multi-band base station antenna refers to a base station antenna capable of operating on two or more frequency bands. For example, a multi-band base station antenna may include one or more arrays of low-band radiating units and one or more arrays of high-band radiating units. The radiating unit may also be referred to as a radiator, radiating element, a radiator unit, or a radiator assembly.

FIGS. 1A and 1B are a partial top view and a perspective view, respectively, of an antenna unit 10′ of a known multi-band base station antenna. A longitudinal section of a reflector plate 1 of the base station antenna and different radiator assemblies 2′, 3, and 4 disposed on the longitudinal section are described in FIGS. 1A and 1B. The antenna unit 10′ as shown in FIGS. 1A and 1B includes: two arrays of radiator assemblies 2′, which are capable of operating in a first frequency band with a first center frequency; two arrays of radiator assemblies 3 arranged on the outer side on the width of the reflector plate 1, which are capable of operating in a second frequency band with a second center frequency; and two arrays of radiator assemblies 4 arranged on the inner side on the width of the reflector plate 1, which are capable of operating in a third frequency band with a third center frequency. The first center frequency is lower than the second center frequency and third center frequency. Relative to each other, the first frequency band may be referred to as a low band, and the second frequency band and the third frequency band may be comparably referred to as high bands. In an exemplary embodiment, the first frequency band may be a frequency band of 698-960 MHz or a portion thereof; and/or the second frequency band may be a frequency band of 1,695-2,690 MHz or a portion thereof; and/or the third frequency band may be a frequency band of 1,427-2,690 MHz or a portion thereof.

Two high-band radiator assemblies 3 and two high-band radiator assemblies 4 are arranged around each low-band radiator assembly 2′ on the reflector plate 1. As best seen in FIG. 1B, each of the radiator assemblies 2′, 3, and 4 may extend forwardly from a front surface of the reflector plate 1, with the radiator assemblies 2′ extending farther from the front surface of the reflector plate 1 than the radiator assemblies 3 and 4 extend from the front surface of the reflector plate 1. The radiator assemblies 3 and the radiator assemblies 4 have a reduced height as compared to the radiator assemblies 2′, and are partially shielded by the radiator assemblies 2′ (i.e., are partially underneath the radiator assemblies 2′ when the antenna is viewed in plan view, as shown in FIG. 1A). Each radiator assembly 2′ occupies a larger area on the reflector plate 1. For example, a single radiator assembly 2′ may occupy an area of 145 mm×145 mm. Each radiator assembly 2′ may have an impact on the radiation performance of the four surrounding high-band radiator assemblies 3 and 4, which is related to the degree that the high-band radiator assemblies are shielded by the low-band radiator assemblies.

### SUMMARY

Aspects of the present disclosure provide a dual-polarized radiator assembly for base station antennas, which may have a compact size and may improve cloaking performance.

A first aspect of the present disclosure relates to a dual-polarized radiator assembly for base station antennas, which includes two orthogonal dipoles, where each dipole includes two dipole arms and each dipole arm has a radiating portion, in which, each radiating portion is a sheet metal component and has an outer contour that basically forms a respective first square, in which, two adjacent inner sides of every two adjacent first squares basically extend parallel to each other.

A second aspect of the present disclosure relates to a dual-polarized radiator assembly for base station antennas, which includes two orthogonal dipoles, where each dipole includes two dipole arms, and each dipole arm has a radiating portion, in which, each radiating portion is constructed with a printed circuit board and each radiating portion has an outer contour that basically forms a respective first square, and the radiating portion includes a plurality of wide sections and a plurality of narrow sections, in which, every two adjacent wide sections are connected through one narrow section, in which, two adjacent inner sides of every two adjacent first squares basically extend parallel to each other.

Compared with the known radiator assembly shown in FIGS. 1A and 1B—each radiating portion of the radiator assembly is constructed in a cross shape or a flower—each radiating portion of the radiator assembly according to the first or second aspect of the present disclosure may have a reduced size as a whole. When the radiator assembly is a low-band radiator assembly and a plurality of high-band radiator assemblies are arranged around the radiator assembly, the low-band radiator assembly shields the high-band radiator assemblies to a lesser degree, which reduces the impact on the high-band radiator assemblies. In other words, the low-band radiator assembly make radio frequency signals transmitted and/or received by the high-band radiator assemblies more transparent, or the low-band radiator assembly may have improved cloaking performance.

In addition, when the dipole arm is constructed with a sheet metal, the radiator assembly may be made in a cost-advantageous manner.

In some embodiments, all radiating portions may have an outer contour that basically forms a second square as a whole.

In some embodiments, each dipole arm may be constructed in the same manner.

In some embodiments, each dipole arm may be constructed differently.

In some embodiments, each dipole arm may have a sheet metal stalk portion, and the stalk portion basically extends orthogonally to the radiating portion.

In some embodiments, the stalk portion and radiating portion of each dipole arm may be a single sheet metal member.

In some embodiments, the stalk portion and radiating portion of each dipole arm may be two separate sheet metal members and are electrically connected to each other, preferably, mechanically connected to each other.

In some embodiments, the radiating portion may include a plurality of wide sections and a plurality of narrow sections, in which, every two adjacent wide sections are connected through one narrow section.

In some embodiments, the radiating portion may include five wide sections and five narrow sections, in which, every two adjacent wide sections are connected through one narrow section.

In some embodiments, the wide sections may have the same width.

In some embodiments, the narrow sections may have the same width.

In some embodiments, each wide section may extend along a side of the first square.

In some embodiments, each narrow section may be bent in a zigzag shape to form a protrusion extending from a side of the first square to the inside of the first square. Typically, each narrow section may be bent in a U shape.

In some embodiments, a first wide section may be angularly constructed, forming a part of two inner sides of the first square and forming an inner corner of the first square.

In some embodiments, two second wide sections may be angularly constructed, forming an inner side and a part of an outer side of the first square respectively, and forming a corner of the first square respectively.

In some embodiments, two third wide sections may extend in a straight line, respectively, forming a part of an outer side of the first square, and together forming an outer corner of the first square.

In some embodiments, a first inner side of the first square may include a first narrow section that forms a first protrusion that extends from the first inner side of the first square to the inside of the first square, and a second inner side of the first square may include a second narrow section that forms a second protrusion that extends from the second inner side of the first square to the inside of the first square.

In some embodiments, respective longitudinal axes of the first and second protrusions may extend in a respective straight line.

In some embodiments, respective longitudinal axes of the first and second protrusions may be colinear.

In some embodiments, a first outer side of the first square may include a third narrow section that forms a third protrusion that extends from the first outer side of the first square to the inside of the first square, and a second outer side of the first square may include a fourth narrow section that forms a fourth protrusion that extends from the second outer side of the first square to the inside of the first square.

In some embodiments, respective longitudinal axes of the third and fourth protrusions may extend in a respective straight line.

In some embodiments, respective longitudinal axes of the third and fourth protrusions may be colinear.

In some embodiments, two outer sides of the first square may be connected to each other through a fifth narrow section, which forms a fifth protrusion that extends from an outer corner of the first square to the inside of the first square.

In some embodiments, the fifth protrusion may extend in a straight line.

In some embodiments, the fifth protrusion may extend in a diagonal line of the first square.

In some embodiments, a free end of the fifth protrusion may be between free ends of the third and fourth protrusions.

In some embodiments, the radiator assembly may include a radiator support, which has a supporting surface, where the supporting surface has a substantially square outer contour and the radiating portion of each dipole arm contact the supporting surface.

In some embodiments, the radiator support may have a central receiving hole, and the stalk portion of each dipole arm is accommodated in the receiving hole; the radiator assembly further includes a feeder line support accommodated in the receiving hole and two sheet metal feeder lines that are mounted to the feeder line support, where each feeder line forms a hook-shaped balun and is constructed to capacitively feed the associated dipole.

In some embodiments, two adjacent ends of every two adjacent wide sections and one narrow section connecting these two wide sections may be constructed as an LC circuit. The two adjacent ends that have a predetermined gap may be constructed as a capacitor and the narrow section may be constructed as an inductor.

In some embodiments, each radiating portion may be constructed in the same layer of the printed circuit board.

In some embodiments, each radiating portion may be constructed in a plurality of layers of the printed circuit board, for example, constructed in two or three layers.

In some embodiments, a first part of each radiating portion may be constructed in a first layer of the printed circuit board, and a second portion of each radiating portion may be constructed in a second layer of the printed circuit board. The first and second parts of the radiating portion are electrically connected to each other, for example, they may be galvanically connected through PTHs.

A third aspect of the present disclosure relates to a dual-polarized radiator assembly, comprising:
a first dipole that includes a first dipole arm and a second dipole arm;
a second dipole that includes a third dipole arm and a fourth dipole arm,
wherein each of the first through fourth dipole arms includes a respective radiating portion that comprises a metal pattern having an outer contour that basically defines a respective first square that has an open interior, wherein the four first squares defined by the radiating portions of the first through fourth dipole arms extend radially from a central location to define a second square, with each of the radiating portions of the first through fourth dipole arms positioned in one of four quadrants of the second square,
wherein the radiating portion of each of the first through fourth dipole arms includes a plurality of wide sections that are interconnected by at least first through fourth narrow sections that extend inwardly into the open interior of the respective first square from respective first through fourth sides of the respective first square.

In some embodiments, the radiating portion of each of the first through fourth dipole arms may further include a fifth narrow section that extends inwardly into the open interior of the respective first square from an outer corner of the respective first square.

The above-mentioned technical features, the technical features to be mentioned below and the technical features shown separately in the drawings may be arbitrarily combined with each other as long as the combined technical features are not contradictory. All feasible feature combinations are technical contents clearly recorded herein. Any one of a plurality of sub-features contained in the same sentence may be applied independently without necessarily being applied together with other sub-features.

### BRIEF DESCRIPTION OF THE DRAWINGS

The present disclosure will be explained in more detail by means of exemplary embodiments with reference to the schematic drawings attached.

FIGS. 1A and 1B are a partial top view and a perspective view, respectively, of an antenna unit of a known multi-band base station antenna.

FIG. 2 is a partial top view of an antenna unit of a multi-band base station antenna according to some embodiments of the present disclosure, in which the base station antenna has two arrays of low-band radiator assemblies according to some embodiments of the present disclosure.

FIG. 3 and FIG. 4 are two different exploded views of a radiator assembly according to some embodiments of the present disclosure.

FIG. 5 is a plan view of the radiating portions of the radiator assembly as shown in FIG. 3 and FIG. 4.

FIG. 6 is a perspective view of a radiator assembly according some embodiments of the present disclosure.

FIG. 7 is a plan view of the radiating portions of a radiator assembly according to some embodiments of the present disclosure.

FIG. 8 is a plan view of the radiating portions of a radiator assembly according to some embodiments of the present disclosure.

### DETAILED DESCRIPTION

Some examples of embodiments of the present application will be described below with reference to the attached drawings. However, it should be understood that the present application may be presented in many different ways and is not limited to the specific embodiments described below. It should also be understood that the embodiments disclosed in the present disclosure may be combined in various ways so as to provide more additional embodiments.

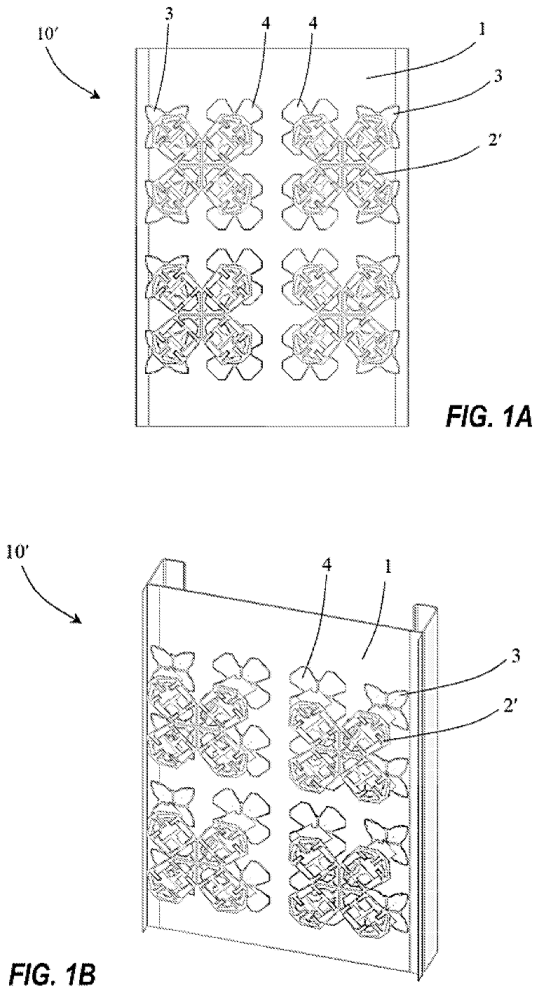

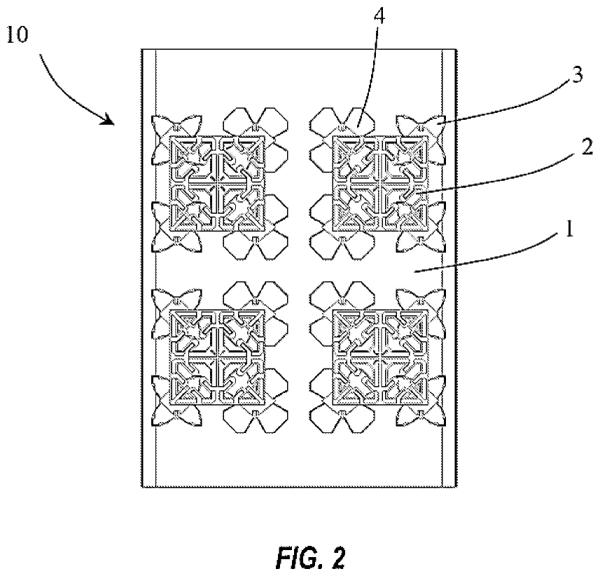

FIG. 2 is a partial top view of an antenna unit 10 of a multi-band base station antenna according to some embodiments of the present disclosure. The antenna unit 10 includes a reflector plate 1. Two arrays of low-band radiator assemblies 2 according to an embodiment of the present disclosure are mounted to extend upwardly or forwardly from the reflector plate 1 (note that when the base station antenna of FIG. 2 is in use the reflector plate 1 will be mounted to extend along a substantially vertical axis, and the radiator assemblies 2 will extend forwardly from the reflector plate 1). In addition, the antenna unit 10 may include two arrays of high-band radiator assemblies 3 that are mounted to extend upwardly or forwardly from the outer sides (in the width direction) of the reflector plate 1 and two arrays of high-band radiator assemblies 4 that are mounted to extend upwardly or forwardly from a central portion of the reflector plate 1. The reflector plate 1, the array of radiator assemblies 3 and the array of radiator assemblies 4 may be constructed in the same or a similar way as the antenna unit 10′ shown in FIGS. 1A and 1B. As stated, FIG. 2 is a partial top view, and accordingly only two radiator assemblies 2 of each array of low-band radiator assemblies 2 are shown. In some embodiments, along an entire longitudinal extension of the reflector plate 1, the number of each array of low-band radiator assemblies 2 may be greater than that shown in FIG. 2, and may be, for example greater than or equal to 6, 10, or 16. The antenna unit 10 may be accommodated in a substantially rectangular radome that is not shown.

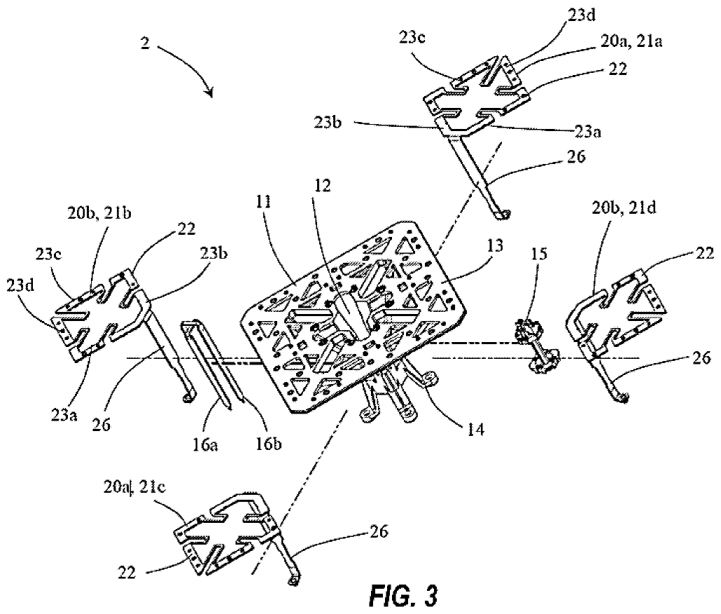

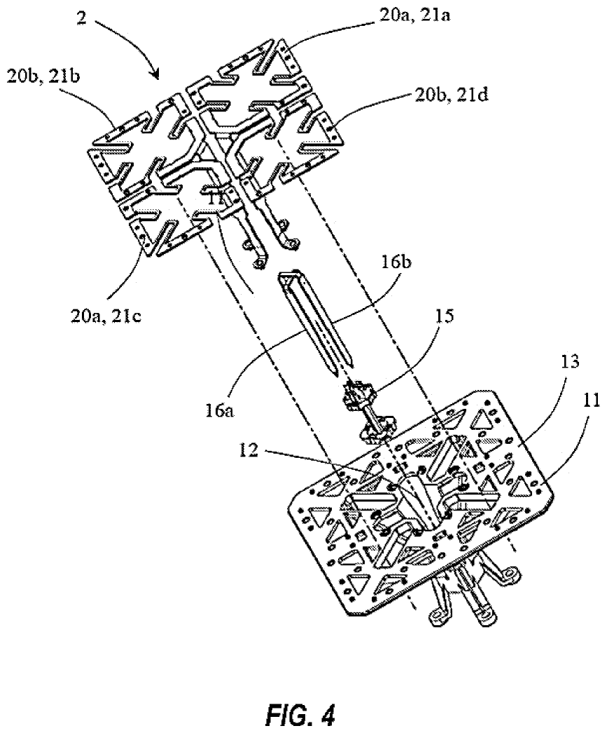

FIG. 3 and FIG. 4 are two different exploded views of a radiator assembly 2 according to some embodiments of the present disclosure, and the radiator assembly 2 may be applied in the antenna unit 10 as shown in FIG. 2 and thereby applied in the base station antenna including the antenna unit 10. FIG. 5 is a plan view of the radiating portions of the radiator assembly as shown in FIG. 3 and FIG. 4.

The radiator assembly 2 includes two orthogonal dipoles 20a and 20b, one of which is +45° slant polarized, and the other is −45° slant polarized. Each dipole, 20a and 20b, includes two dipole arms. Specifically, dipole 20a includes two dipole arms 21a and 21c, and dipole 20b includes two dipole arms 21b and 21d. Each dipole arm, 21a, 21b, 21c, and 21d, has a radiating portion 22 and a stalk portion 26. The stalk portion 26 and the radiating portion 22 may extend orthogonally to each other (e.g., basically orthogonal or substantially orthogonal). The radiating portion 22 may be a sheet metal component. The stalk portion 26 may be a sheet metal component. Advantageously, the radiating portion 22 and the stalk portion 26 may be a single sheet metal member (such as a member formed by stamping sheet metal). Alternatively, the radiating portion 22 and the stalk portion 26 may be two separate sheet metal components that are electrically connected to each other. These two separate sheet metal components may be mechanically and galvanically connected to each other or, alternatively, may be capacitively coupled to each other. In an embodiment that is not shown, the radiating portion 22 may be a sheet metal component, and the dipole arm does not have a stalk portion 26 made with a sheet metal.

Referring now to FIGS. 2-5 inclusive, each radiating portion 22 may have an outer contour that basically forms a first square. Taken collectively, that is as a whole, the radiating portions 22 of the two orthogonal dipoles 20a and 20b may have an outer contour that basically forms a second (larger) square. Two adjacent inner sides 23a and 23b of every two adjacent first squares basically extend parallel to each other. As there is a gap between each radiating portion 22, the area of the second square is slightly larger than four times the area of each first square.

In an exemplary embodiment, each side of the second (larger) square may be 126 mm in length. That is to say, each radiator assembly 2 occupies or overlaps an area of 126 mm×126 mm on the reflector plate 1. Compared with the radiator assembly 2′ that occupies an area of 145 mm×145 mm as shown in FIGS. 1A and 1B, the radiator assembly 2 is significantly more compact and occupies a significantly smaller area on the reflector plate 1, and the operating frequency band of the radiator assembly 2 may be basically the same as the operating frequency band of the radiator assembly 2′. In addition, as seen in FIG. 2, each low-band radiator assembly 2 may be less shielded by the surrounding high-band radiator assemblies 3 and 4, so it may exert less interference on these high-band radiator assemblies 3 and 4, in other words, the low-band radiator assembly 2 may have improved cloaking performance.

Referring to FIG. 3, the radiator assembly 2 may further include a radiator support 11. The radiator support 11 may have a supporting surface 13, which may have a substantially square outer contour. The radiating portion 22 of each dipole arm 21a, 21b, 21c, and 21d may be supported by the supporting surface 13. Each radiating portion 22 may be fixed on the supporting surface 13 through one or more fastening elements. In an embodiment that is not shown, each radiating portion 22 may be equipped with a lid that may be detachably fixed to the supporting surface 13 and cover the corresponding radiating portion 22. The radiator support 11 may have a plurality of feet 14. The radiator support 11 may be mounted to the reflector plate 1 using fastening elements through the feet 14, or it may be soldered to a plate assembly (e.g., a feed board printed circuit board) that is mounted on the reflector plate 1.

The radiator support 11 may have a central opening 12. The stalk portion 26 of each dipole arm 21a, 21b, 21c, or 21d may be inserted into the opening 12. In addition, the radiator assembly 2 may further include a feeder line support 15, which may be inserted into the opening 12. An associated first feeder line 16a of the dipole 20a and an associated second feeder line 16b of the dipole 20b may be mounted onto the feeder line support 15 and may be inserted into and maintained in the opening 12 together with the feeder line support 15. Each feeder line support 16a, 16b may be formed of stamped and bent sheet metal. Each feeder line, 16a and 16b, may form a hook-shaped balun and may be constructed for capacitively feeding the associated dipoles 20a and 20b.

As best seen in FIG. 5, the radiating portion 22 of each dipole arm, 21a, 21b, 21c, and 21d, may include a plurality of wide sections 24a, 24b, 24c, 24d, and 24e and a plurality of narrow sections 25a, 25b, 25c, 25d, and 25e, in which, every two adjacent wide sections 24 are connected through a narrow section 25. Each wide section 24 may have the same or different width. Each narrow section 25 may have the same or different width. As more clearly shown in FIG. 5, in some embodiments there may be five wide sections 24 and five narrow sections 25, and in embodiments that are not shown, it is possible to have other quantities of wide sections and narrow sections.

In the embodiment shown, a first wide section 24a that is angularly constructed extends along two inner sides 23a and 23b of the first square. The first wide section 24a forms part of the two inner sides 23a and 23b and may be constructed as an inner corner of the first square. A second wide section 24b that is angularly constructed extends along the inner side 23b and outer side 23c of the first square, is constructed as a part of the two sides 23b and 23c and is constructed as a corner. Another second wide section 24e that is angularly constructed extends along the outer side 23d and inner side 23a of the first square, is constructed as a part of the two sides 23d and 23a and is constructed as a corner. A third wide section 24c extends along the outer side 23c of the first square and is constructed as a part of the side 23c. Another third wide section 24d extends along the outer side 23d of the first square and is constructed as a part of the side 23d. The two third wide sections 24c and 24d are jointly constructed as an outer corner of the first square.

In the embodiment shown, each narrow section 25a, 25b, 25c, 25d, or 25e may be bent in a zigzag shape or U shape to form a protrusion formed from a side of the first square to the inside of the first square. The two inner sides 23a and 23b of the first square are respectively equipped with a narrow section 25a, 25b, which form a first and a second protrusion extending from the corresponding inner sides 23a and 23b of the first square to the inside of the first square. Respective longitudinal axes of the two protrusions may extend in a straight line, particularly may be colinear, in which, there is a 45° included angle between the first and second protrusions and the corresponding inner sides. The two outer sides 23c and 23d of the first square may be respectively equipped with a narrow section 25c and 25e, which form a third and a fourth protrusion extending from the corresponding outer sides 23c and 23d of the first square to the inside of the first square. Respective longitudinal axes of the third and fourth protrusions may extend in a straight line, particularly, may be colinear, in which, there is a 45° included angle between the third and fourth protrusions and the corresponding outer sides. The two outer sides 23c and 23d of the first square may be connected to each other through a fifth narrow section 25d, which forms a fifth protrusion extending from an outer corner of the first square to the inside of the first square. The fifth protrusion may extend in a straight line, particularly, the fifth protrusion may extend in a diagonal line of the first square. For example, a free end of the fifth protrusion may be between free ends of the third and fourth protrusions. In an embodiment that is not shown, the protrusion constructed by any narrow section 25a, 25b, 25c, 25d, or 25e may extend in a curved manner.

Herein, two adjacent ends of every two adjacent wide sections, 24a, 24b, 24c, 24d and 24e, and one narrow section 25a, 25b, 25c, 25d, or 25e that connects these two wide sections may be constructed as a LC circuit, in which, the two adjacent ends with a predetermined gap may be constructed as a capacitor and the one narrow section may be constructed as an inductor. The cloaking performance of the radiator assembly 2 may be improved through an adaptive LC circuit, and the radiator assembly 2 may exert less interference on the surrounding high-band radiator assemblies 3 and 4.

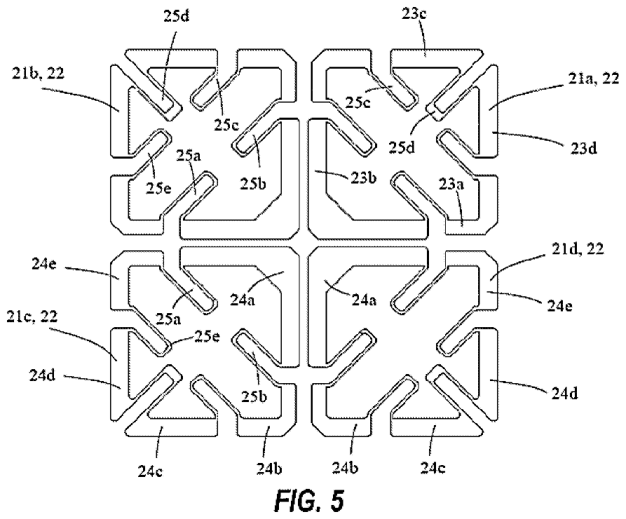

FIG. 6 is a perspective view of a radiator assembly 102 according to some embodiments of the present disclosure. The radiator assembly 102 may be applied in the antenna unit 10 as shown in FIG. 2 in a similar manner to the radiator assembly 2. In the embodiment as shown in FIG. 6, similar or functionally similar components in the embodiments shown in FIGS. 2 to 5 are provided with reference numbers that increased by 100 from the corresponding reference numerals in FIGS. 2 to 5. The dual-polarized radiator assembly 102 includes two orthogonal dipoles 120a and 120b. The dipole 120a includes a pair of dipole arms 121a and 121c. The dipole 120b includes a pair of dipole arms 121b and 121d. Each dipole arm has a radiating portion 122. In the embodiment as shown in FIG. 6, the construction and arrangement of each radiating portion 122 may be the same as or similar to the configuration and arrangement of each radiating portion 22 in the embodiments as shown in FIGS. 2 to 5. Herein, each radiating portion 122 is made of printed circuit boards. Each radiating portion 122 may be constructed in the same layer of the printed circuit board.

The radiator assembly 102 may further include two feeder printed circuit boards 116a and 116b for feeding dipoles 120a and 120b. The two feeder printed circuit boards 116a and 116b may intersect each other and be used as support for the printed circuit boards constructed for each radiating portion 122 and may be mounted on a reflector plate that is not shown, for example, soldered onto a feeder panel constructed with a printed circuit board that is applied on the reflector plate.

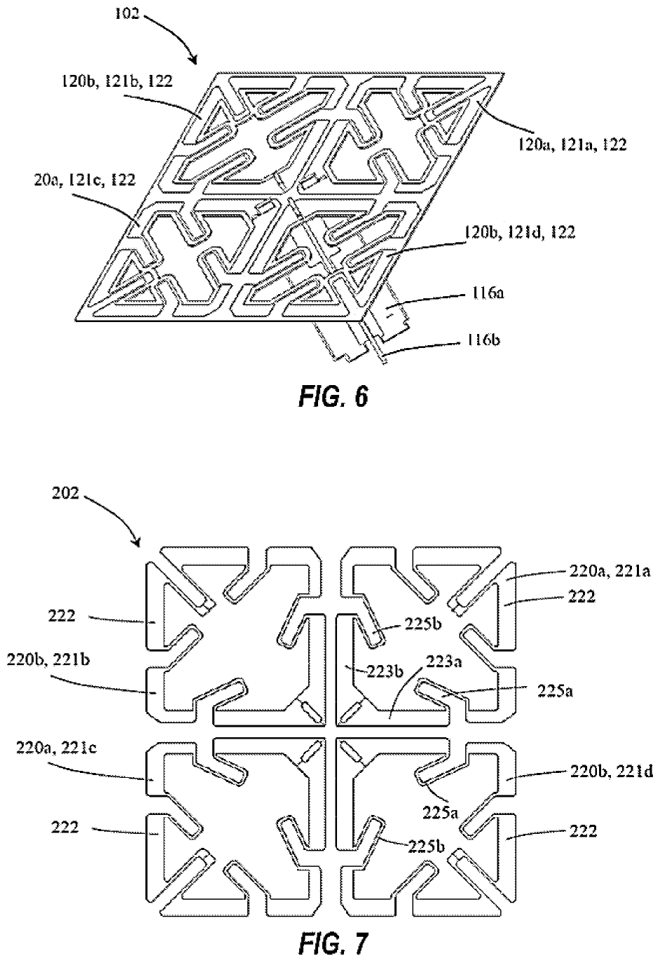

FIG. 7 is a plan view of the radiating portions of a radiator assembly 202 according to some embodiments of the present disclosure. In the embodiment as shown in FIG. 7, similar or functionally similar components in the embodiments shown in FIGS. 2 to 5 are provided with the reference numbers that are increased by 200 from the corresponding reference numbers in FIGS. 2 to 5. In the embodiment as shown in FIG. 7, dipole arms 221a, 221b, 221c, and 221d of dipoles 220a and 220b may be realized with a sheet metal as shown in the embodiments in FIGS. 2 to 5, or may be realized by a printed circuit board as shown in the embodiment in FIG. 6. The radiator assembly 202 may be applied in the antenna unit 10 as shown in FIG. 2 in a similar manner to the radiator assembly 2.

The radiator assembly 202 of the embodiment as shown in FIG. 7 and the radiator assembly 102 of the embodiment as shown in FIG. 6 may only have the following differences: the two narrow sections 225a and 225b of each radiating portion 222 form a first and a second protrusion that extend in a straight line, respectively, and there is an approximately 300 included angle between the first and second protrusions and the corresponding inner sides 223a and 223b of the first square. Respective longitudinal axes of the first and second protrusions are not colinear.

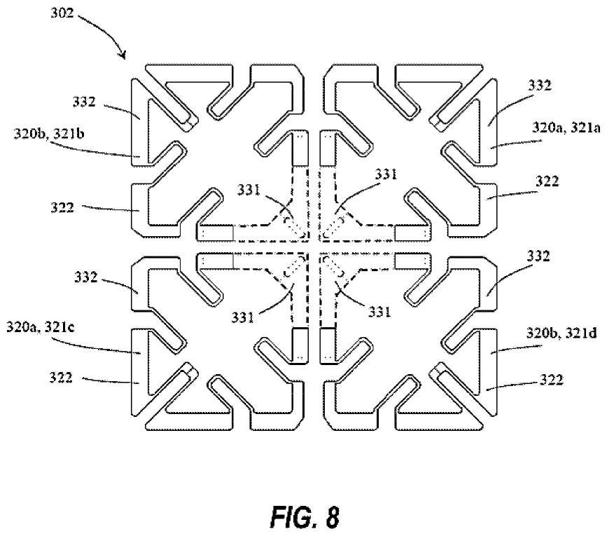

FIG. 8 is a plan view of each radiating portion of a radiator assembly 302 according to some embodiments of the present disclosure. The radiator assembly 302 may be applied in the antenna unit 10 as shown in FIG. 2 in a similar manner to the radiator assembly 2. In the embodiment as shown in FIG. 8, similar or functionally similar components in the embodiments shown in FIGS. 2 to 5 are provided with reference numbers that are increased by 300 from the corresponding reference numbers in FIGS. 2 to 5.

The radiator assembly 302 of FIG. 8 and the radiator assembly 102 of the embodiment as shown in FIG. 6 may only have the following differences: each radiating portion 322 of dipole arms 321a, 321b, 321c, and 321d of dipoles 320a and 320b is constructed in a plurality of layers of the printed circuit board, in which, each radiating portion 321 includes a first part 331 and a second part 332, in which, the first part 331 is constructed in a first layer of the printed circuit board, the second part 332 is constructed in a second layer of the printed circuit board, and the first part 331 and second part 332 may be electrically connected, for example, galvanically connected through PTHs.

In a variant that is not shown, each radiating portion of the radiator assembly may include the first part 331 constructed with a printed circuit board as shown in FIG. 8 and a second part that is not constructed with a printed circuit board but with a sheet metal and has the same configuration and arrangement as the second part 332 as shown in FIG. 8. In this variant, the first part and second part may be galvanically connected or capacitively coupled.

It should be noted that the terminology used here is only for the purpose of describing specific aspects, and not for limiting the disclosure. The singular forms “a” and “the one” as used herein shall include plural forms, unless the context explicitly states otherwise. It can be understood that the terms “including” and “inclusive” and other similar terms, when used in the application documents, specify the existence of the stated operations, elements and/or components, and do not exclude the existence or addition of one or more other operations, elements, components and/or combinations thereof. The term “and/or” as used herein includes all of any combinations of one or more relevant listed items. In the description of the attached drawings, similar reference numerals always indicate similar elements.

The thickness of the elements in the attached drawings may be exaggerated for clarity. In addition, it can be understood that if an element is referred to as being on, coupled to, or connected to, another element, then the said element may be directly formed on, coupled to, or connected to the other element, or there can be one or more intervening elements between them. Conversely, if the expressions “directly on,” “directly coupled to” and “directly connected to” are used herein, it means that there are no intervening elements. Other words used to describe the relationship between elements should be interpreted similarly, such as “between” and “directly between,” “attached” and “directly attached,” “adjacent” and “directly adjacent” and so on.

Terms such as “top,” “bottom,” “upper,” “lower,” “above,” “below,” etc. herein are used to describe the relationship of one element, layer or region with respect to another element, layer or region as shown in the attached drawings. It can be understood that in addition to the orientations described in the attached drawings, these terms should also include other orientations of the device.

It can be understood that although the terms “first,” “second,” etc. may be used herein to describe different elements, these elements should not be limited by these terms. These terms are only used to distinguish one element from another. Therefore, the first element can be referred to as the second element without departing from the teachings of the concept of the present disclosure.

It may also be considered that all the exemplary embodiments disclosed herein may be arbitrarily combined with each other.

Finally, it should be pointed out that the aforementioned embodiments are only used to understand the present disclosure, and do not limit the protection scope of the present disclosure. For those of ordinary skill in the art, modifications can be made on the basis of the aforementioned embodiments, and these modifications do not depart from the protection scope of the present disclosure.

1. A dual-polarized radiator assembly for base station antennas, comprising:
first and second orthogonal dipoles, each of the first and second dipoles including two dipole arms, each dipole arm including a radiating portion, wherein each radiating portion is a sheet metal component and has an outer contour forming a respective first square, in which, two adjacent inner sides of every two adjacent first squares extend in parallel to each other.

2. The radiator assembly according to claim 1, wherein as a whole, all of the radiating portions of the radiator assembly have an outer contour that collectively form a second square.

3. The radiator assembly according to claim 1, wherein each dipole arm has a sheet metal stalk portion, and the stalk portion extends orthogonally to the radiating portion.

4. The radiator assembly according to claim 3, wherein the stalk portion and radiating portion of each dipole arm is a single sheet metal member.

5. The radiator assembly according to claim 1, wherein the radiating portion includes a plurality of wide sections and a plurality of narrow sections, in which, every two adjacent wide sections are connected through one narrow section.

6. The radiator assembly according to claim 5, wherein each wide section extends along a side of the first square and each narrow section is bent in a zigzag shape to form a protrusion extending from a side of the first square to an inside of the first square.

7. The radiator assembly according to claim 5, wherein a first wide section among all wide sections is angularly constructed, forming a part of two inner sides of the first square and forming an inner corner of the first square.

8. The radiator assembly according to claim 5, wherein two second wide sections among all wide sections are angularly constructed, forming an inner side and a part of an outer side of the first square, respectively, and forming a corner of the first square, respectively.

9. The radiator assembly according to claim 5, wherein two third wide sections among all wide sections extend in a straight line, respectively, forming a part of an outer side of the first square, and together forming an outer corner of the first square.

10. The radiator assembly according to claim 6, wherein a first inner side of the first square includes a first narrow section that forms a first protrusion that extends from the first inner side of the first square to the inside of the first square, and a second inner side of the first square includes a second narrow section that forms a second protrusion that extends from the second inner side of the first square to the inside of the first square.

11. The radiator assembly according to claim 10, wherein respective longitudinal axes of the first and second protrusions are colinear.

12. The radiator assembly according to claim 6, wherein a first outer side of the first square includes a third narrow section that forms a third protrusion that extends from the first outer side of the first square to the inside of the first square, and a second outer side of the first square includes a fourth narrow section that forms a fourth protrusion that extends from the second outer side of the first square to the inside of the first square.

13. The radiator assembly according to claim 12, wherein respective longitudinal axes of the third and fourth protrusions are colinear.

14. The radiator assembly according to claim 6, wherein first and second outer sides of the first square are connected to each other through a fifth narrow section that forms a fifth protrusion that extends from an outer corner of the first square to the inside of the first square.

15. The radiator assembly according to claim 14, wherein the fifth protrusion extends in a straight line.

16. The radiator assembly according to claim 15, wherein the fifth protrusion extends in a diagonal line of the first square.

17. The radiator assembly according to claim 12, wherein the first and second outer sides of the first square are connected to each other through a fifth narrow section that forms a fifth protrusion that extends from an outer corner of the first square to the inside of the first square and a free end of the fifth protrusion is between free ends of the third and fourth protrusions.

18-19. (canceled)

20. The radiator assembly according to claim 1, wherein two adjacent ends of every two adjacent wide sections and one narrow section connecting these two wide sections are constructed as an LC circuit.

21-37. (canceled)

38. A dual-polarized radiator assembly, comprising:
a first dipole that includes a first dipole arm and a second dipole arm; and
a second dipole that includes a third dipole arm and a fourth dipole arm,
wherein each of the first through fourth dipole arms includes a respective radiating portion that comprises a metal pattern having an outer contour that defines a respective first square that has an open interior, wherein the four first squares defined by the radiating portions of the first through fourth dipole arms extend radially from a central location to define a second square, with each of the radiating portions of the first through fourth dipole arms positioned in one of four quadrants of the second square,
wherein the radiating portion of each of the first through fourth dipole arms includes a plurality of wide sections that are interconnected by at least first through fourth narrow sections that extend inwardly into the open interior of the respective first square from respective first through fourth sides of the respective first square.

39. The radiator assembly according to claim 38, wherein the radiating portion of each of the first through fourth dipole arms further includes a fifth narrow section that extends inwardly into the open interior of the respective first square from an outer corner of the respective first square.
